(19) United States
(12) Patent Application Publication
(10) Pub. No.: US 2006/0097127 A1
(43) Pub. Date: May 11, 2006

(54) Device

(76) Inventor: Andrew Charles Firth, Letchworth Garden City (GB)

Correspondence Address: CALFEE HALTER & GRISWOLD, LLP, 800 SUPERIOR AVENUE, SUITE 1400, CLEVELAND, OH, 44114, US

(21) Appl. No.: 10/983,931

(22) Filed: Nov. 8, 2004

(30) Foreign Application Priority Data
Nov. 7, 2004 (GB) 0326013.0

(51) Int. Cl. B22C 9/22; A23G 9/00; E04G 17/00

(52) U.S. Cl. 249/58; 249/203; 249/205

(57) ABSTRACT

A device for projecting into a substance, comprises two substantially planar flaps 4 having respective first edge zones 6 and respective second edge zones 8. The respective first edge zones 6 are interconnected in the manner of a hinge 10 which has an axis of turning 12 about which the flaps 4 can turn relative to each other. Each of the edge zones 8 of the device 2 has one or more projecting lugs 14 for immersing in the substance and located between a series of steps 16. The device is inserted into the substance which is initially in a substantially liquid state but subsequently hardens to a substantially solid state, such that the projecting lugs of the device become embedded in the substantially solid substance. Most preferably, the substantially liquid material is water and the substantially solid material is ice, in the form of an ice cube. The substantially solid substance is released from the device by squeezing the two substantially planar flaps 4.

This invention relates to a device for projecting into and later releasing a substance, in particular to a device for projecting into a substance of a substantially liquid state and later releasing that substance subsequent to its changing its physical state to a substantially solid state.

According to one aspect of the present invention, there is provided a device for projecting into a substance and later, with said substance in a substantially solid state, releasing said substance, comprising first and second flaps hingedly interconnected with each other and having respective edge zones including at least one lug for projecting into said substance.

Owing to this aspect of the invention, it is possible to provide a device which can be caused to project into a substance, while said substance is in a state to flow around the lug(s) or in a state in which the lug(s) can be inserted into the substance, and subsequently squeezed to release the substance from the device when the substance is in a substantially solid state.

Preferably, the device is inserted into a substance which is initially in a substantially liquid state but subsequently hardens to a substantially solid state, such that the projecting lug(s) of the device become embedded in the substantially solid substance. Most preferably, the substantially liquid material is water and the substantially solid material is ice, in the form of an ice cube.

According to a second aspect of the present invention, there is provided, in combination,

a container for a substance and having an open top, and devices for projecting into said substance with said substance in a substantially solid state, said container being formed with locators for retaining the respective devices in respective desired positions relative to the container.

Owing to this aspect of the invention, the devices are deterred from shifting out of their desired positions relative to the container.

A consumer can be supplied with the container for holding one or more units of a substance, together with one or more devices for projecting into and later releasing the units. Preferably, the container is an ice cube tray and the or each device supplied therewith is utilised to be frozen into an ice cube and later to release the ice cube from the device.

According to a third aspect of the present invention, there is provided, in combination, a substance in a substantially solid state and a device projecting into said substance, the arrangement being such that squeezing of said device releases said substance from said device.

According to a fourth aspect of the present invention, there is provided a method comprising causing a device to project into a substance, and squeezing said device to cause said substance, in a substantially solid state, to be released from said device.

Owing to these two aspects of the invention, it is possible to arrange that a substantially solid substance into which a carrying device projects can be released from the device by simply squeezing the device.

In order that the invention may be clearly and completely disclosed, reference will now be made, by way of example, to the accompanying drawings, in which:—

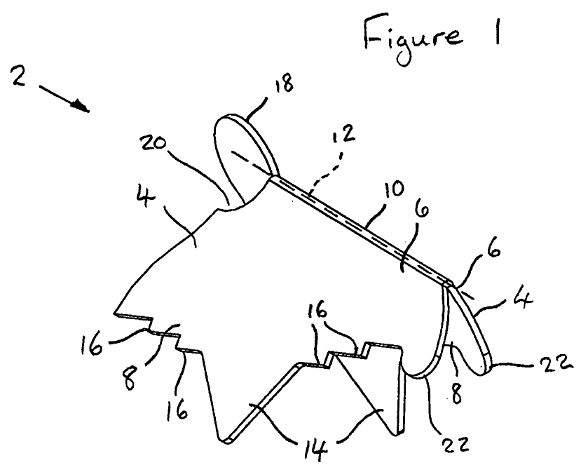

FIG. 1 is a perspective view from above of a preferred, first embodiment of a device for projecting into and releasing a unit of a substance,

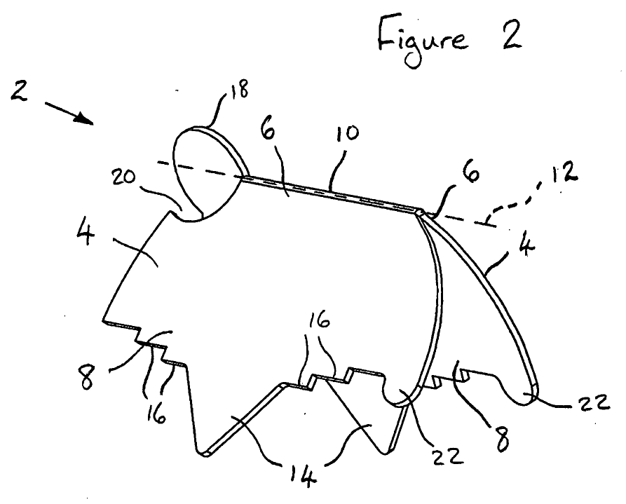

FIG. 2 is a view similar to FIG. 1, but of a second embodiment of the device,

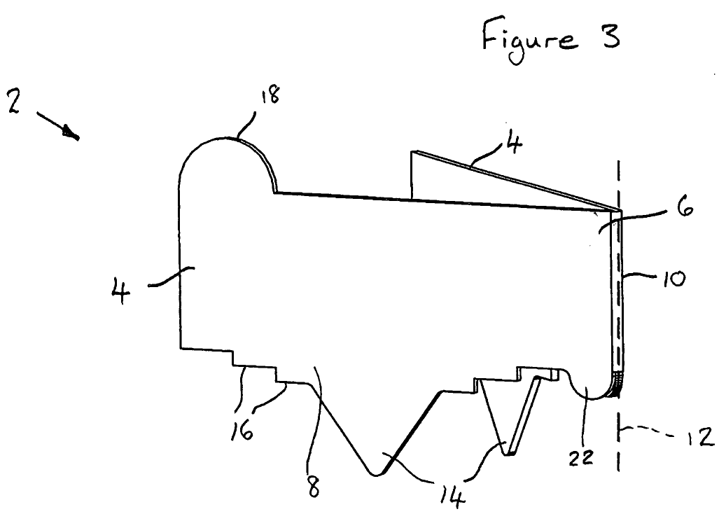

FIG. 3 is a view similar to FIG. 1, but of a third embodiment of the device,

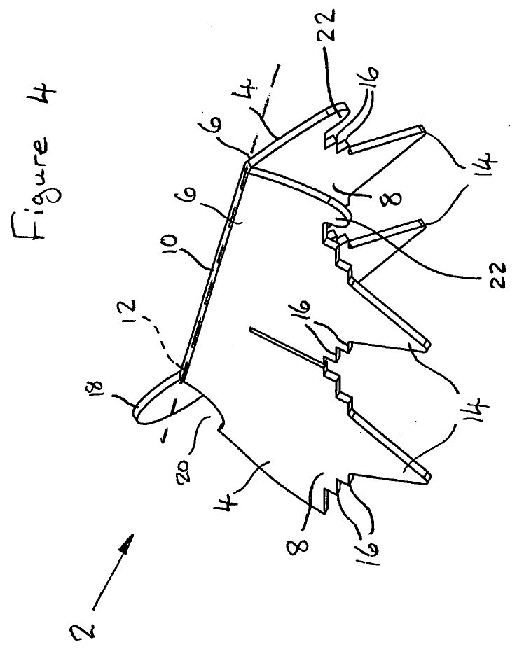

FIG. 4 is a view similar to FIG. 1, but of a fourth embodiment of the device,

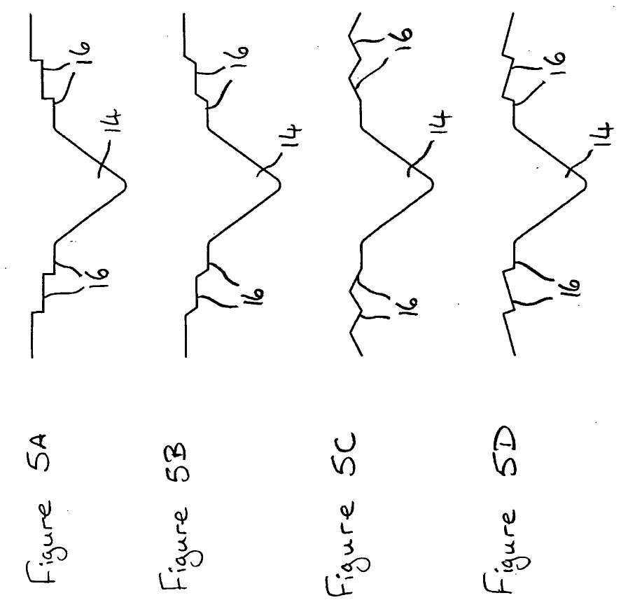

FIGS. 5A to 5D show respectively various partial profiles of an outer edge of the device,

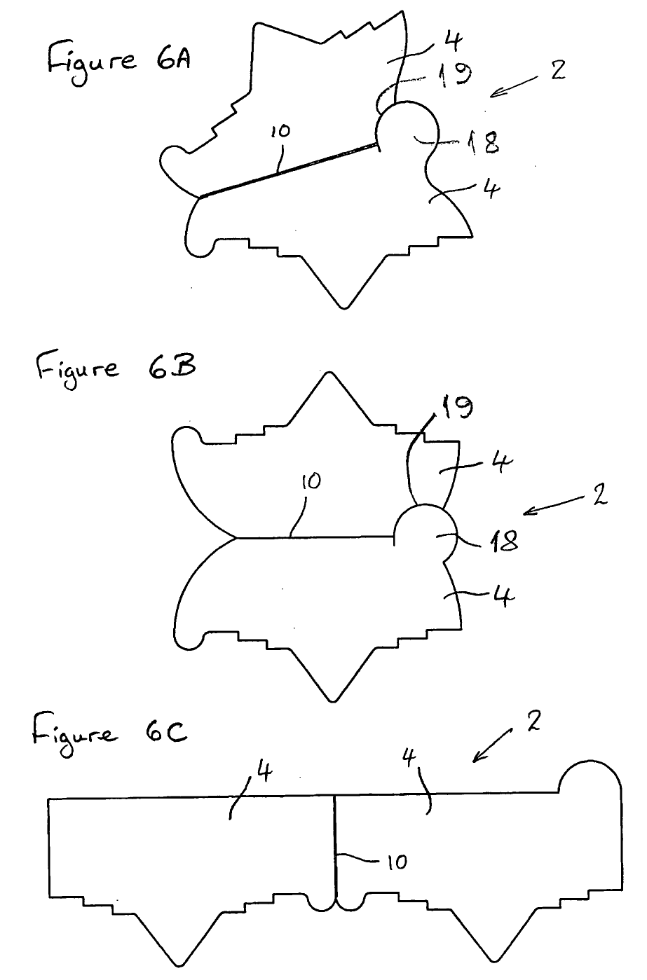

FIGS. 6A, 6B and 6C are plan views of the first, second and third embodiments, respectively, of the device in a flat condition,

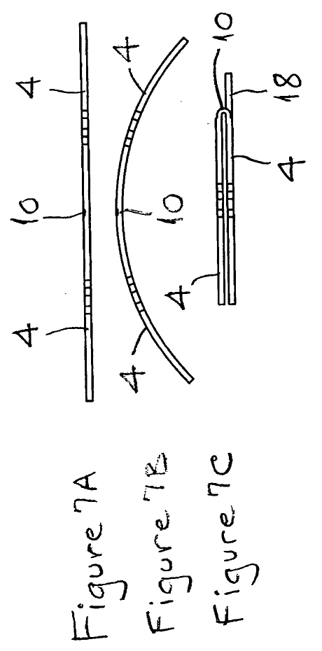

FIGS. 7A, 7B and 7C are end views of the embodiment of FIG. 1 in various conditions for packaging and/or storage and/or transport, and

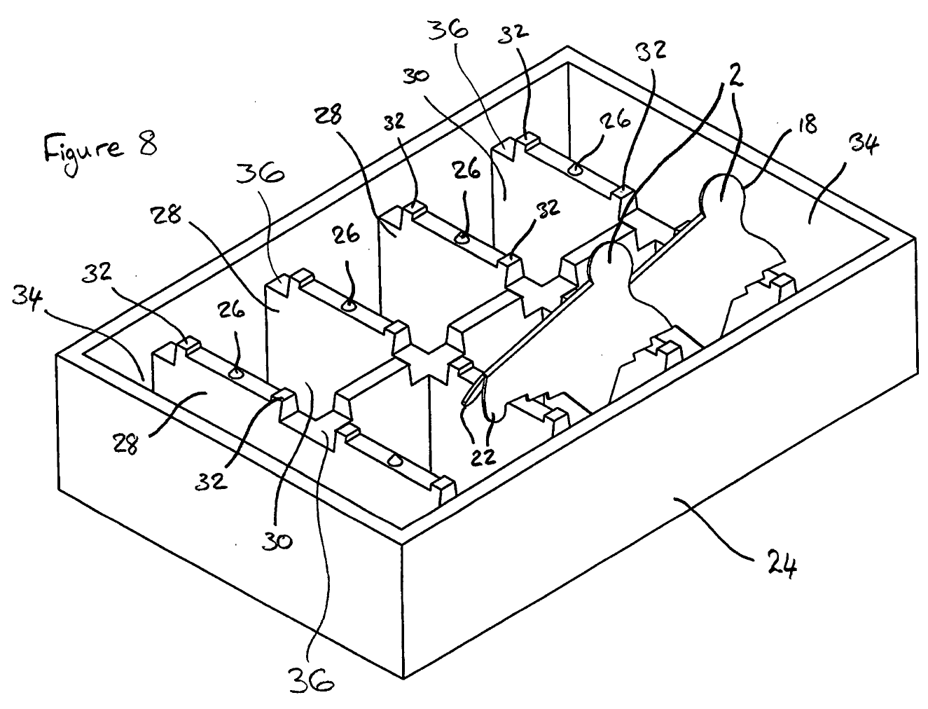

FIG. 8 is a perspective view from above of a divided container including two devices of the embodiment shown in FIG. 1.

Referring to FIGS. 1 to 4, a device 2 for being caused to project into a unit of liquid, particularly water, (not shown) in an ice cube tray and for subsequent release of the ice cube formed by the unit of water from the device 2 to deposit the ice cube into a drink, for example, comprises two substantially planar flaps 4 having respective first edge zones 6 and respective second edge zones 8. The respective first edge zones 6 are interconnected in the manner of a hinge 10 which has an axis of turning 12 about which the flaps 4 can turn relative to each other. In FIGS. 1, 2 and 4, the second edge zones 8 are radially outer and thus opposite the first edge zones 6, and in FIG. 3 the first edge zones 6 are adjacent the second edge zones 8.

Each of the edge zones 8 of the device 2 has one or more projecting lugs 14 located between a series of steps 16. As can be seen from FIGS. 5A to 5D, the steps 16 in the edge zones 8 can be of a variety of profiles and assist a user when positioning the device 2 centrally over a cell of an ice cube tray, to try to ensure that only the lugs 14 become immersed in the liquid in the cell of the ice cube tray prior to freezing. FIG. 5A shows a preferred design in which the step profile is substantially a right angle with the steps having increasing horizontal length as they move away from the lug 14. FIG. 5B shows steps 16 having sloping vertical faces between the steps. This is intended to allow the vertical faces to conform better to the sloped sides of some ice cube trays. FIG. 5C shows a step profile having shallow symmetrical saw-like teeth. These saw-like teeth hold the location of the device less effectively than the other stepped profiles, on the one hand, but, on the other hand, do not result in such large changes of height of the lugs 14 between narrow ice tray cells and wide ice tray cells. FIG. 5D shows a version of the device 2 having asymmetrical saw-like teeth. This profile retains the location of the device almost as well as that of the version of FIG. 5A while minimising the height changes for the lug 14 between narrow and wide ice cube cell walls.

The embodiment shown in FIG. 4 has two lugs 14 on each of the second edge zones 8 and could be utilised to be positioned across two adjacent cells of an ice cube tray.

In use, the cells of an ice cube tray are filled with liquid to be frozen, such that, when the devices 2 are placed over the cells so as to straddle the width of an ice cube cell, the lugs 14 are partially immersed in the liquid.

After a change in physical state from a liquid to a solid by freezing, the ice cube tray can be twisted, as is conventional, or otherwise disturbed, to break the bond between each ice cube (if water is used) and its ice cube cell walls. One or more ice cubes having the lugs 14 of a device 2 incorporated therein by the freezing process can be lifted from the tray, either by using a dedicated tag 18 which projects upwardly when the device 2 is in use, or by gently squeezing the planar flaps 4 between the thumb and forefinger. Each device 2 of FIGS. 1, 2 and 4 is symmetrical about the hinge 10, except for the tag 18 and the corresponding inset 19.

The lugs 14 connect to the ice cube in two ways:—
i) as a surface to which the ice adheres and hence the ice cube attaches, and
ii) as a displacement device so as to form a mechanical interlock with the ice cube.

With the ice cube supported by the device 2 over a desired release location, such as over a drink, the flaps 4 can be squeezed towards each other (the outer surfaces of the flaps 4 possibly having marked thereon respective squeeze areas), so prompting the release of the ice cube from the lugs 14 by:—
i) fracturing the ice,
ii) breaking the adhesion bond of the ice with the lugs 14, and
iii) releasing the mechanical interlock formed with the frozen ice cube by pushing away of the ice cube from the device 2.

Grasping of the tag 18 between the thumb and forefinger allows the device 2 to be lifted from the ice cube tray with the ice cube still attached while minimising the risk of ejecting the ice cube as may happen if the device 2 were to be grasped by applying the thumb and forefinger against the respective outer surfaces of the flaps 4. The tag 18 is preferably formed to be always co-planar with one of the flaps 4 and is located at one end of the device 2 and projects upwardly when in use. It could alternatively be located, between two hinge lengths, at a midzone of a first edge zone 6, such that the tag 18 would, in use, be above the lugs 14.

The embodiments shown in FIGS. 1, 2 and 4 include a lifting recess 20 located beneath the tag 18 in use and allowing the user to employ a finger to help support the device 2 as it is manipulated and the ice cube is deployed.

The lugs 14 can have pointed or rounded ends and have a broad range of possible profiles and angles. The preferred shape has lugs 14 that have substantially straight edges, an internal angle of a range between about 20 and about 75 degrees, and a tightly rounded nose. Other possible lug designs have curved edges of either concave or convex form to reduce further the ice bonding surface while further expanding the range of liquid levels in an ice cube tray cell that can be optimally tolerated.

The hinge 10 can also be of various forms. FIG. 2 shows a device which has a parallel hinge, i.e. a hinge which is substantially horizontal when the device is in use. This arrangement enables the lugs 14 to enter the fluid of the ice cube tray cell obliquely, which eases ejection of the subsequent ice cube by making the ice slip planes converge and allows the lugs 14 to act as ejectors. However, this arrangement makes placing devices 2 in neighbouring ice cube cells of an ice cube tray somewhat difficult since the neighbouring devices cannot readily nest into each other at their ends. FIG. 3 shows a version of the device 2 having a perpendicular hinge, i.e. a hinge which is substantially vertical when the device is in use. This arrangement enables in a simple manner the placement of devices in neighbouring ice cube cells on an ice cube tray since the substantially vertical hinge of one device can be placed between the parted flaps of the neighbouring device. However, the vertical hinge design leaves the plane of each lug 14 sitting vertically, perpendicular to the surface of the liquid, and hence makes difficult subsequent ice cube ejection by squeezing of the device.

Each of the embodiments of the device 2 shown in FIGS. 1 and 4 has an oblique hinge, i.e. a hinge which is obliquely inclined to the vertical when the device is in use. This arrangement combines the advantageous features of both the substantially horizontal and the substantially vertical hinge designs described above, and allows the device 2 both to nest and have lugs 14 slope obliquely to the vertical making ice cube release a more elegant process than is the case with vertical lugs.

The ability to nest allows successive devices 2 to nest along a common centreline parallel to the axis 12 by allowing the lower end of each device (i.e. that end opposite the tag 18) to nest beneath the higher end of a neighbouring device 2 where the tag 18 is located. The obliquely angled lugs 14 incorporated in the frozen water act as bonds, latches and ejectors.

The currently preferred hinge is made by forming a strip of reduced thickness along the hinge 10; however, it could instead be made by intermittently perforating the device along the hinge 10 by providing either holes or slits.

As mentioned above, the higher of the two ends of the device 2 shown in FIG. 1 or 4 leaves a space beneath into which the lower end of a neighbouring device 2 can be placed. In this fashion, the steps 16 of those two devices can rest upon a common ice cube cell boundary wall.

The device 2 shown in FIG. 4 can also employ the parallel hinge arrangement shown in FIG. 2 or the perpendicular hinge arrangement shown in FIG. 3.

The preferred form of the device for delivery to the customer is as a flat device as shown in FIG. 6A, 6B, or 6C, and 7A. Prior to use, the customer simply folds the device along the hinge 10 to make it usable. FIG. 6A shows the flat, pre-folded, form of the device 2 shown in FIG. 1 and is of a substantially compact form and can thus be readily attached to and inserted in a broad range of articles as well as be easily packaged for independent sale. FIG. 6B shows the flat, pre-folded, form of the device 2 shown in FIG. 2. This design is again of comparatively compact form for attachment to a broad range of articles and for packaging for independent sale. FIG. 6C shows the flat, pre-folded, form of the device 2 of FIG. 3. This flat form is not as compact as the flat forms of FIGS. 6A and 6B, but can still be attached to a broad range of articles and can be sold independently.

In the flat form shown in FIGS. 6A to 6C, and indicated in FIG. 7A, the device 2 could, as already mentioned, be packaged for sale as a stand-alone product, or adhered to, latched onto, or otherwise connected to, many forms of articles, and in particular packaging articles including boxes, multi-can and multi-bottle packs, single cans and bottles, and plastics and paperboard fluid containers. If the device 2 is folded flat along the hinge 10, as indicated in FIG. 7C, this can substantially reduce the area required for attachment to an article and thus the device could be placed in a smaller area. Alternatively, the flat form of the device 2 can be gently curved, as indicated in FIG. 7B, to fit on the curved surface of cylindrical items and elements of items such as cans and bottles. The devices 2 could also be provided preformed, when the devices 2 do not require folding by hand, which may suit customers when the devices are sold independently. The device 2 may be formed in other configurations for shipping to best suit the article to which it is being applied and/or the manner in which it is being promoted. One such example is a conical configuration to fit closely around a substantially conical neck of some bottles.

The device 2 is also provided with relatively small rounded projections 22 at those ends of the respective second edge zones 8 further from the tag 18, the projections 22 being co-planar with the respective flaps 4. The projections 22 enable a user's finger to be hooked underneath the device 2 to help support the device 2 as it is manipulated and the ice cube is deployed.

The device 2 could be manufactured from a broad range of materials, such as plastics, metals, paper, and cardboard, employing a range of methods of forming. Preferably, the device 2 is manufactured from polypropylene, because the device 2 needs to be inert for inserting into consumable liquids and flexible for being attached to various forms of articles, and is formed by die-cutting of a sheet of polypropylene; however, it could alternatively be manufactured using laser cutting, CNC forming, or injection moulding. The preferred polypropylene thickness is between 0.6 mm and 1.2 mm, 0.8 mm being the preferred thickness and 1.2 mm being believed to be the maximum for the device to be fully effective. However, the material thickness is driven by a careful balance of many features including material and material properties, surface finish, coatings, lug size, and hinge type.

The device 2 can, of course, be made in a wide range of colours, both solid and translucent if made from plastics, to suit marketing and promotional requirements.

The designated squeeze areas on the outsides of the flaps 4 which define an area above each lug 14 where optimal ejection can be effected can be coincident with a logo which can be printed on, or preferably embossed in the flaps 4. These squeeze areas are prime locations for branding and liveries.

Referring to FIG. 8, two devices 2 of the embodiment shown in FIG. 1 are shown in place in an ice cube tray 24 designed to work with the devices 2. To ensure that the devices 2 sit centrally over cells 30 of the ice cube tray 24, the tray 24 has, on the boundary walls 28, central locating protrusions 26 among longitudinally aligned neighbouring ice cube cells 30 and outer retaining protrusions 32 to minimise the risk of the devices 2 moving laterally. In addition, the ice cube tray 24 could include overspill zones 34 located among or at the raw ends (as shown) of the ice cube cells 30 to capture any excess liquid poured into the ice cube tray 24 and could also include overspill channels 36 leading towards those zones 34, so assisting the development of a consistent water level across the entire tray, so that the lugs 14 of the devices 2 are sufficiently immersed in the liquid in the cells 30 for sufficient incorporation into the ice cubes. The central locating protrusions 26 ensure that the narrow ends of the devices 2, where the rounded projections 22 of the devices 2 are located, are not readily displaced from the central positions. Similarly, the outer retaining protrusions 32 ensure that the wider ends of the devices 2, where the tags 18 are located, are not readily displaced from the central positions.

The device 2 of FIG. 1 is the preferred design, in that it can be seated upon the widest range of ice cube tray sizes. It also offers the benefits of being both small and employing little material, making it ideal as a promotional item to be attached to separately marketed articles as well as for marketing in its own right. The dual ice cube lifting device 2 shown in FIG. 4 is a development of the preferred design, for projecting into and deposition of two ice cubes. It would also be possible to provide a device for projecting into three or more ice cubes simultaneously. Such a design, however, would probably not fit the existing wide range of ice cube tray cell sizes and thus may require a dedicated ice cube tray design, for example according to FIG. 8.

If manufactured from sheet material, especially plastics, a plurality of devices 2 can be partially cut-out, with the devices still being attached to the sheet material by small bridges which can be subsequently broken by a user when pushing the devices out of the sheet. The user then folds each device along the hinge 10 to form the device 2 ready for use.

The device 2 can be used in substances that do not require freezing to change their physical states. For example, the device 2 could be used in confectionery-making, especially for instance toffee, which is initially in a substantially liquid state when poured into a mould. Whilst the toffee is in that state, the device 2 could be incorporated into the toffee and the steps 16 of the device 2 supported by the mould, the lugs 14 becoming incorporated into the toffee as it hardens to a solid state. The device 2 can then be used to remove the hardened toffee from the mould. Whether the device 2 would then be squeezed to eject the unit of toffee or the unit of toffee pulled from the device by the consumer's hand or lips would be a matter of choice.

I claim:

1. A device for projecting into a substance and later, with said substance in a substantially solid state, releasing said substance, comprising first and second flaps hingedly interconnected with each other and having respective edge zones including at least one lug for projecting into said substance.

2. A device according to claim 1, wherein said prior to being in said substantially solid state is in a substantially liquid state, the arrangement being such that the lug(s) of said device become embedded in the substantially solid substance.

3. A device according to claim 2, wherein said substantially liquid material is water and the substantially solid material is ice.

4. A device according to claim 1, wherein said first and second flaps are substantially planar.

5. A device according to claim 1, wherein said first and second flaps lie in planes which converge towards each other.

6. A device according to claim 1, wherein said first and second flaps are hingedly interconnected by a hinge which is substantially obliquely inclined to the vertical when said device is in use.

7. A device according to claim 6, wherein said hinge is formed by a strip of reduced thickness at the interconnection of said first and second flaps.

8. A device according to claim 1, wherein said respective edge zones further include one or more of a series of steps.

9. A device according to claim 1, wherein said respective edge zones include two lugs.

10. A device according to claim 1, and further comprising a tag for lifting said device.

11. A device according to claim 10, wherein said tag is co-planar with one of the first or second flaps.

12. A device according to claim 10, wherein said tag is located at one end of said device and projects upwardly in use.

13. A device according to claim 10, and further comprising a lifting recess located, when in use, beneath said tag.

14. A device according to claim 1, and further comprising respective small rounded projections co-planar with the respective first and second flaps.

15. A device according to claim 14, wherein a tag is located at one end of said device and projects upwardly in use and said small rounded projections are located at an opposite end of said device and project downwardly in use.

16. A device according to claim 1, wherein said lug(s) are substantially triangular in shape.

17. A device according to claim 16, wherein said lug(s) have substantially straight edges, an internal angle of between about substantially 20 and about substantially 75 degrees, and a tightly rounded nose.

18. A device according to claim 1, wherein squeezing of said device releases said substance from said device.

19. A device according to claim 18, wherein said first and second flaps are squeezed towards each other.

20. A device according to claim 19, wherein said first and second flaps have marked thereon designated squeeze areas.

21. A device according to claim 1, and further comprising a container for said substance having an open top, and being formed with locators for retaining the respective devices in respective desired positions relative to the container.

22. A device according to claim 21, wherein said container includes one or more cells for holding one or more units of said substance bounded by walls, the arrangement being such that, when one of said devices is placed over said cell so as to straddle the cell, said lug(s) project into said cell.

23. A device according to claim 22, wherein said container is an ice cube tray.

24. A device according to claim 22 wherein respective edge zones of said device further include one or more of a series of steps which when placed on the boundary walls, locate said device centrally over said cell.

25. A device according to claim 22, wherein said locators include central locating protrusions on the boundary wall between longitudinally aligned neighbouring cells.

26. A device according to claim 25 and further comprising respective small rounded projections co-planar with said first and second flaps, wherein said central locating protrusions retain in position the narrowest end of said device where said small rounded projections are located.

27. A device according to claim 22, wherein said locators include outer retaining protrusions.

28. A device according to claim 27 and further comprising a tag co-planar with one of the first or second flaps, wherein said outer retaining protrusions retain in position the widest end of said device where said tag is located.

29. A device according to claim 21, wherein said container includes an overspill zone.

30. A device according to claim 29, wherein said container further includes an overspill channel communicating with said overspill zone.

31. In combination, a container for a substance and having an open top, and devices for projecting into said substance with said substance in a substantially solid state, said container being formed with locators for retaining the respective devices in respective desired positions relative to the container.

32. A combination according to claim 31, wherein a single one of said devices is that according to any one claims 1 to 20.

33. In combination, a substance in a substantially solid state and a device projecting into said substance, the arrangement being such that squeezing of said device releases said substance from said device.

34. A combination according to claim 33, wherein said device is according to any one claims 1 to 20.

35. A method comprising causing a device to project into a substance, and squeezing said device to cause said substance, in a substantially solid state, to be released from said device.

36. A method according to claim 35, wherein said device comprises first and second flaps hingedly interconnected with each other and having respective edge zones including at least one lug for projecting into said substance.

37. A method according to claim 36, wherein the lug(s) are inserted into said substance.

38. A method according to claim 35, wherein said device projects obliquely into said substance.

39. A method according to claim 36, wherein said substance is initially in a substantially liquid state subsequently hardening to a substantially solid state, such that the projecting lug(s) of the device become embedded in the substantially solid substance.

40. A method according to claim 35, and further comprising filling a container with said substance and placing said device relative to said container for projecting into said substance.

41. A method according to claim 40, wherein said container is for holding one or more units of said substance, together with one or more respective devices for projecting into said units.

42. A method according to claim 36, wherein said first and second flaps of said device are squeezed to release said substance in said substantially solid state.
